(19) United States
(12) Patent Application Publication
(10) Pub. No.: US 2024/0191948 A1
(43) Pub. Date: Jun. 13, 2024

(54) A METHOD OF MANUFACTURING AN ENERGY EXCHANGING DEVICE

(71) Applicant: INDIAN INSTITUTE OF SCIENCE, Bangalore (IN)

(72) Inventors: Pramod KUMAR, Bangalore (IN); Vijay BIRADAR, Bangalore (IN); Vivek PANDEY, Bangalore (IN)

(21) Appl. No.: 18/553,081

(22) PCT Filed: Mar. 9, 2022
(86) PCT No.: PCT/IB2022/052081

§ 371 Date: Sep. 28, 2023

(30) Foreign Application Priority Data
Mar. 31, 2021 (IN) 202141015190

(51) Int. Cl. F28D 9/00; B23P 15/26

(52) U.S. Cl. CPC F28D 9/0062; B23P 15/26

(57) ABSTRACT

The present disclosure discloses a method (200) of manufacturing an energy exchanging device (100). The method includes defining a plurality of through slots (14, 17) in a plurality of plates (2) by a through cut machining process, in which, each of the plurality of through slots define a flow channel. The method further includes stacking the plurality of plates (2) with at least one blanking member (24) positioned therebetween. Such stacking of the plurality of plates (2) forms a plurality of fluid flow paths about the plurality of through slots. The method further includes bonding the at least one blanking member with the plurality of plates, to form an energy exchanging core (1). The method further includes defining at least two inlet ports (45a, 45b) and at least two outlet ports (46a, 46b) in the core, for flow of fluid along the plurality of fluid flow paths within the core.

### TECHNICAL FIELD

The present disclosure, in general, relates to the field of mechanical engineering. Particularly, but not exclusively, the present disclosure relates to energy exchanging devices. Further, embodiments of the present disclosure relate to a method of manufacturing energy exchanging devices, such as, but not limited to, microchannel heat exchangers, like Printed Circuit Heat Exchangers (PCHEs), and fuel cells, like hydrogen fuel cell.

### BACKGROUND OF THE DISCLOSURE

Energy exchanging devices such as microchannel heat exchangers in the form of Printed Circuit Heat Exchangers (PCHEs) are employed in applications demanding high energy interaction locations for optimal performance at extreme operating surroundings. Such devices are generally required to be robust, compact and lighter in weight, which make such devices suitable for the extreme operating surroundings such as, high-temperature and/or high-pressure.

Manufacturing such energy exchanging devices is generally a complex process involving a number of intricate manufacturing techniques that may range from some hours of a day to about few days. Conventionally, energy exchanging devices such as, but not limited to PCHE, are manufactured by complex process such as photochemical etching and diffusion bonding processes, where a plurality of plates are stacked and joined to allow flow of fluids, respectively. FIG. 1 illustrates a flow chart of such conventional method 10 of manufacturing PCHEs. Initially, fluid flow paths or channels are defined in the plates by photochemical etching, as depicted at 11. Subsequent to forming the flow channels, the plates are stacked up 12 and are fixed by diffusion bonding to form an energy exchanger core 13. Further, the energy exchanger core may be accommodated within a housing, and the plates may be fluidly communicated with an inlet and outlet conduit of hot fluid and cold fluid, respectively, to perform heat exchange.

Processes such as, photochemical etching, are performed to ensure burr-free plate surfaces on the plates while preserving metal properties in unaltered condition. Use of diffusion bonding, a solid-state joining process, to join plates will prevent formation of joints or weld beads that may act as points of failure in the energy exchanging core. However, photochemical etching and diffusion bonding are time consuming and expensive metalworking processes and employing such processes in manufacturing of the energy exchanging devices results in overall increase of delivery time, which inherently increases costs of such devices as well. Also, servicing of such energy exchanging devices may render expensive due to high-end process involved in manufacturing. In spite of being highly efficient and compact, high initial and servicing costs of the energy exchanging device prevents them from being used in industrial setups, powerplants that require low cost heat/energy exchanging solutions.

The present disclosure is directed to overcome one or more limitations stated above.

### SUMMARY OF THE DISCLOSURE

One or more shortcomings of the prior art are overcome by a method and a device as claimed and additional advantages are provided through the method and the device as claimed in the present disclosure. Additional features and advantages are realized through the techniques of the present disclosure. Other embodiments and aspects of the disclosure are described in detail herein and are considered a part of the claimed disclosure.

In one non-limiting embodiment of the disclosure, a method of manufacturing an energy exchanging device is disclosed. The method includes defining, a plurality of through slots in a major surface of a plurality of plates by a through cut machining process, in which, each of the plurality of through slot defines a flow channel. The method further includes stacking, the plurality of plates with at least one blanking member positioned at both the major surfaces of each of the plurality of plates to form a plurality of fluid flow paths about the plurality of through slots. The method also includes bonding, the at least one blanking member with the major surface of each of the plurality of plates, to form an energy exchanging core. The method further includes defining, at least two inlet port and at least two outlet port in the energy exchanging core, for flow of fluid along the plurality of fluid flow paths within the energy exchanging core.

In an embodiment, the through cut machining process includes at least one of a laser machining, wire electrical discharge machining (wire EDM), Waterjet cutting, Electrochemical etching, micro milling, and spark erosion machining or any other through cut machining process.

In an embodiment, the plurality of through slots are defined on the major surface of each of the plurality of plates by defining a marginal space at edges of the corresponding plate of the plurality of plates.

In an embodiment, the blanking member is at least one of a solid plate and/or a selective diffusion membrane.

In an embodiment, the plurality of flow channels are defined with a predetermined profile including at least one of a straight profile, zig-zag profile, serpentine profile, and S-shaped profile or any other profile including any combination of above.

In an embodiment, the plurality of plates spaced by the at least one blanking member is stacked such that, each plate of the plurality of plates on either side of the at least one blanking member is defined with the plurality of flow channels with at least one predetermined profile including at least one of a straight profile, zig-zag profile, serpentine profile, and S-shaped profile or any other profile including any combination of above.

In an embodiment, stacking of the plurality of plates includes disposing at least one blanking member to form a base for the energy exchanging core. The stacking of the plurality of plates further includes interposing at least one plate of the plurality of plates between the plurality of blanking members. The plurality of plates and the at least one blanking member are progressively and relatively positioned such that, the at least one blanking member on both the major faces of each plate define the plurality of fluid flow path about the plurality of through slots for fluid flow through the energy exchanging core.

In an embodiment, the bonding includes applying, an adhesive bond between the major surface of the plurality of plates and the at least one blanking member while stacking. The bonding further includes heating, the stack of the plurality of plates and the at least one blanking member by a joining process including at least one of a vacuum brazing, diffusion bonding, soldering and welding, or any other joining process to form the energy exchanging core.

In an embodiment, defining the at least two inlet port and the at least two outlet port in the energy exchanging core includes machining a portion of the blanking member and the marginal space defined at the opposing ends of the plurality of plates by a material removal process including at least one of a milling, drilling, blanking and wire electrical discharge machining (wire EDM) process or any other machining process

In another non-limiting embodiment of the disclosure, an energy exchanging device including an energy exchanging core is disclosed. The energy exchanging core includes a plurality of plates, each defined with a plurality of through slots in a major surface by a through cut machining process, in which each of the plurality of through slot defines a flow channel. The energy exchanging core further includes at least one blanking member, positioned at both the major surfaces of each of the plurality of plates to form a plurality of fluid flow paths about the plurality of through slots, in which the at least one blanking member is bonded with the major surface of each of the plurality of plates, to form an energy exchanging core. The energy exchanging core also includes at least two inlet ports and at least two outlet ports that are defined in the energy exchanging core by selectively machining portions of the at least one blanking member and the plurality of plates, for flow of fluid along the plurality of fluid flow paths within the energy exchanging core. The energy exchanging core further includes at least one manifold fluidically connected to each of the at least two inlet port and the at least two outlet port to circulate the fluid through the energy exchanging core.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a flow chart of a conventional method of manufacturing Printed Circuit Heat Exchangers (PCHEs).

FIG. 2 illustrates a perspective view of an energy exchanging device, in accordance with an embodiment of the present disclosure.

FIGS. 3a, 3b and 3c illustrate planar views of a hot fluid plate, in accordance with some embodiments of the present disclosure.

FIGS. 4a, 4b and 4c illustrate planar views of a cold fluid plate, in accordance with some embodiments of the present disclosure.

FIG. 5 illustrates an exploded perspective view of a stack of plurality of plates constituting a unit of an energy exchanging core, in accordance with an embodiment of the present disclosure.

FIG. 6 illustrates an exploded perspective view of an energy exchanging core of the energy exchanging device, in accordance with an embodiment of the present disclosure.

FIG. 7 illustrates a perspective view of a top cover plate of the energy exchanging device, in accordance with an embodiment of the present disclosure.

FIG. 8 illustrates a perspective view of a bottom cover plate of the energy exchanging device, in accordance with an embodiment of the present disclosure.

FIG. 9 illustrates perspective views of a diffuser of the energy exchanging device, in accordance with an embodiment of the present disclosure.

FIG. 10 illustrates an assembled perspective view of the energy exchanging core, in accordance with an embodiment of the present disclosure.

FIG. 11 illustrates another assembled perspective view of the energy exchanging core in which the inlet and outlet portions of plurality of through slots has been exposed, in accordance with an embodiment of the present disclosure.

FIG. 12 illustrates an exploded perspective view of a manifold of the energy exchanging device, in accordance with an embodiment of the present disclosure.

FIGS. 13a, 13b and 13c illustrate perspective views of various combinations of the hot fluid plate and the cold fluid plate, in accordance with some embodiments of the present disclosure.

FIG. 14 is a flow chart of a method of manufacturing the energy exchanging device, in accordance with an embodiment of the present disclosure.

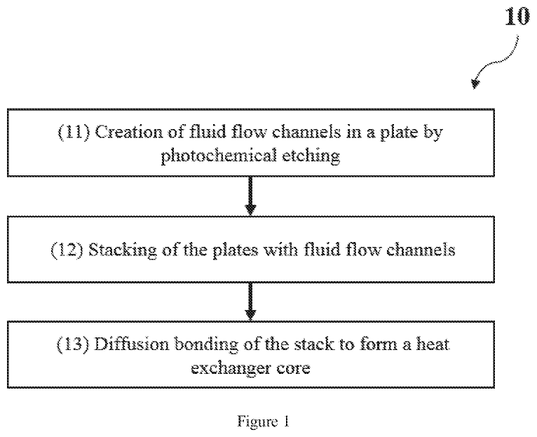

The figures depict embodiments of the disclosure for purposes of illustration only. One skilled in the art will readily recognize from the following description that alternative embodiments of the system and method illustrated herein may be employed without departing from the principles of the disclosure described herein.

### DETAILED DESCRIPTION

While the embodiments in the disclosure are subject to various modifications and alternative forms, specific embodiments thereof have been shown by way of example in the figures and will be described below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof used in the disclosure, are intended to cover a non-exclusive inclusion, such that a device, assembly, mechanism, system, method that comprises a list of components does not include only those components but may include other components not expressly listed or inherent to such system, or assembly, or device. In other words, one or more elements in a system proceeded by “comprises . . . a” does not, without more constraints, preclude the existence of other elements or additional elements in the system or mechanism.

Embodiments of the present disclosure disclose an energy exchanging device and a method of manufacturing the energy exchanging device. The method includes defining a plurality of through slots in a major surface of a plurality of plates. The plurality of through slots are defined by a through cut machining process. Each of the plurality of through slots, defined in each of the plurality of plates, defines a flow channel for flow of fluid. The method further includes stacking the plurality of plates with at least one blanking member positioned at both the major surfaces of each of the plurality of plates. Such stacking of the plurality of plates with at least one blanking member positioned therebetween, results in formation of a plurality of fluid flow paths about the plurality of through slots. The method further includes bonding the at least one blanking member with the major surface of each of the plurality of plates. Such bonding is performed to form an energy exchanging core of the energy exchanging device. The method further includes defining at least two inlet ports and at least two outlet ports in the energy exchanging core. The at least two inlet ports and at least two outlet ports are defined by selectively machining portions of the at least one blanking member and the plurality of plates. The inlet ports and the outlet ports facilitate the entry and exit of the fluid, respectively, from the energy exchanging core. Fluid introduced by the inlet ports into the energy exchanging core, flows through the plurality of fluid flow paths within the energy exchanging core, and exits the energy exchanging core through the outlet ports, while undergoing energy exchange therewithin. At least one manifold is fluidically connected to each of the at least two inlet ports and the at least two outlet ports to supply and circulate the fluid through the energy exchanging core.

The term ‘energy exchanging device’ (also referred to as “the device”), as used herein refers to any device capable of exchanging energy such as, but not limited to, heat, electric charge (or ions), and other forms of energy between two fluids. Such energy exchanging devices include, but may not be limited to, a micro-channel heat exchanger, a printed circuit heat exchanger (PCHE), a compact plate heat exchanger, fuel cells, battery modules, and the like.

Further, the phrase ‘method of manufacturing the energy exchanging device’ (also referred to as method of manufacturing or method hereinafter), as used herein includes fabrication and assembly of standard and/or specialized parts to form components that are part of or to be used as a part of the energy exchanging devices during manufacturing.

Additionally, the term ‘fluid’ as used herein refers to a gas and/or a liquid that may be employed as a working fluid in the energy exchanging device. Further, such fluid may be capable of interaction with the structural constituents of the energy exchanging devices and with other fluids that may be selectively supplied and/or channelized in the energy exchanging devices. The interaction between the fluid within the energy exchanging devices may be physical [that is, either direct contact or indirect contact] or chemical [that is, either change in chemical composition or ionic composition]. The fluid may be configured to exchange energy in the form of either heat or ions, within the energy exchanging device.

In addition, the term “through slot” referred herein, can be interpreted as cutouts formed by either removing material or by forming such cutouts as an integral part during manufacturing of a component/element of the energy exchanging device. Further, removal of material from the component/element may be performed about a selective dimension [that is, about length, width or thickness/depth] of such component/element, where material is completely removed along a predefined pattern about such dimension of the component/element to form void space along the predefined pattern. That is, no material of the component/element exists in such through slot formed therein. Also, one would appreciate that the slots formed by selectively adding material on surface(s) of the component/element of the energy exchanging device, is a different technological principle, which cannot be construed similar to the “through slots” defined hereinafter in the detailed description.

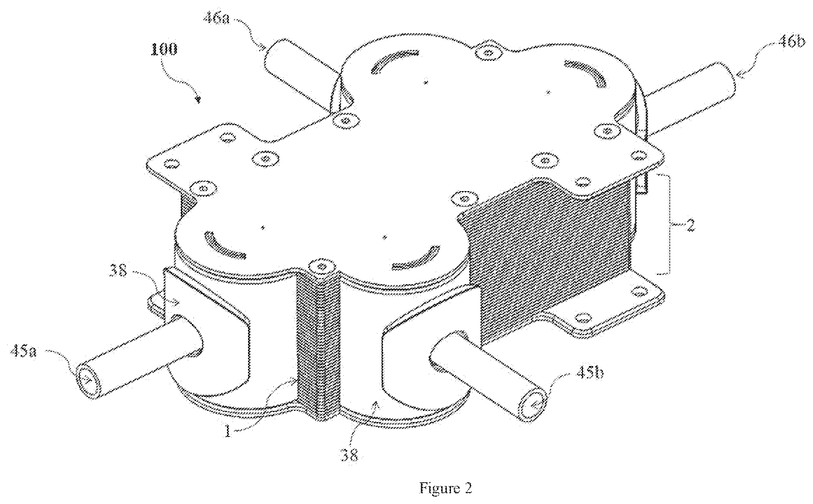

The disclosure is described in the following paragraphs with reference to FIGS. 2 to 14. In the figures, the same element or elements which have same functions are indicated by the same reference signs. It is to be noted that, entire working setup of the energy exchanging device is not illustrated in the figures for the purpose of simplicity. One skilled in the art would appreciate that the method for manufacturing the device and the device as disclosed in the present disclosure may be used in industrial setups, such as, but not limited to, oil refineries and petrochemical plants employing microchannel heat exchangers, waste heat recovery facilities, refrigeration and air-conditioning facilities, energy stations such as reactors including power generation reactors, thermal reactors and the like.

FIG. 2 is an exemplary embodiment of the present disclosure which illustrates a perspective view of the energy exchanging device (100) including an energy exchanging core (1) (also referred to as “the core” hereinafter). The core (1) may be a structure formed and adapted to communicate fluid flow for energy interaction and/or exchange in the energy exchanging device (100). The core (1) may be selectively enclosed in order to allow flow of fluid into and out from the core (1), while at the same time, mitigate leakage of fluid and/or energy therefrom. In an embodiment, the core (1) may be connected to manifolds (38) for enabling flow of fluid into and out from the core (1).

Additionally, the core (1) may be hermitically sealed about a top region and a bottom region, in order to avoid intrusion of foreign particles and/or interaction of surrounding temperature and pressure on the flow of fluid within the core (1).

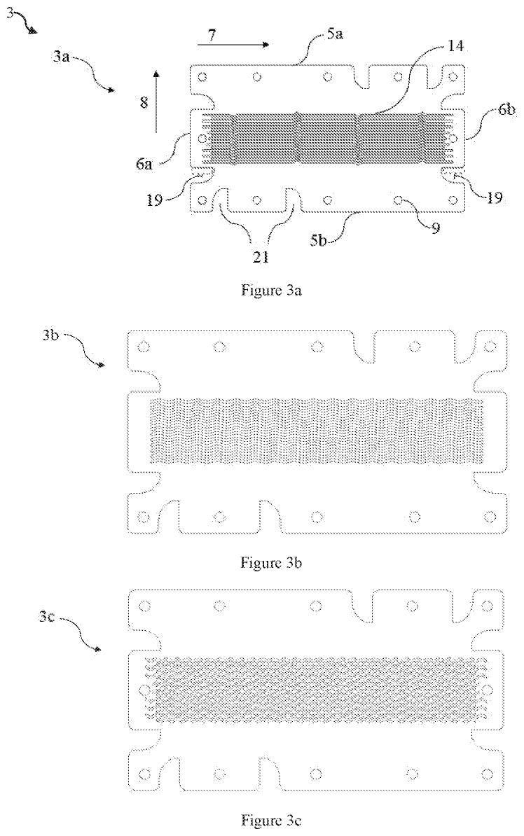

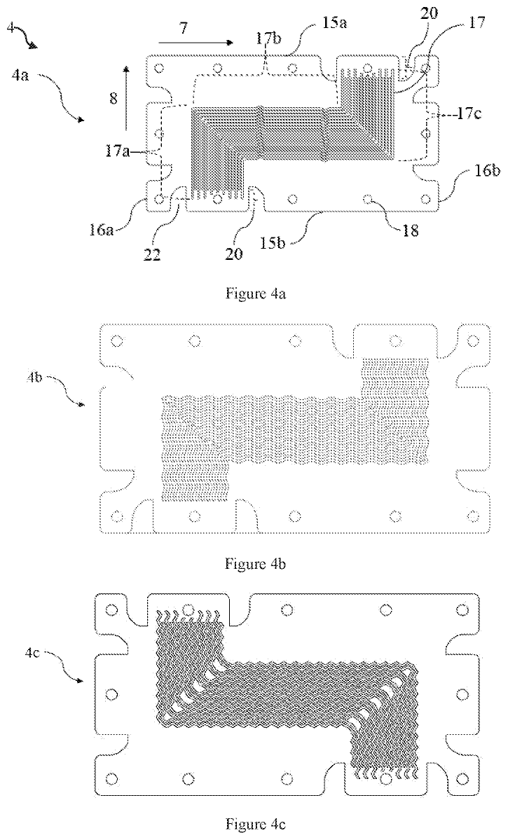

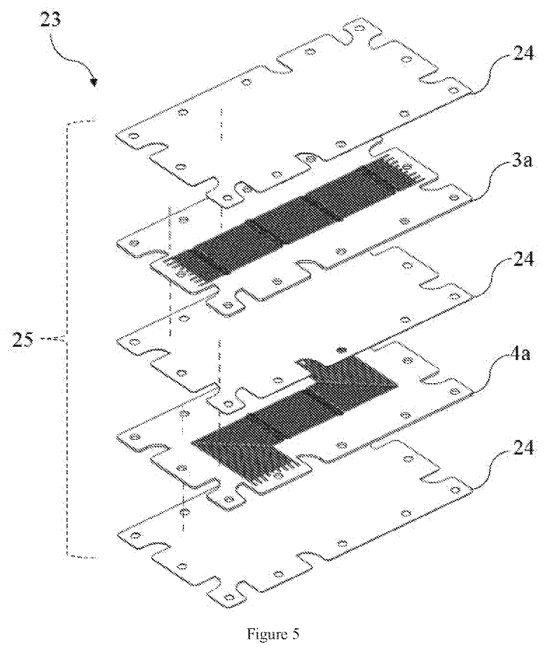

Further, the core (1) may include a plurality of plates (2), as best seen in FIGS. 3a-3c and FIGS. 4a-4c. Each plate of the plurality of plates (2) may be defined with a plurality of through slots (14, 17), for at least one of fluid flow and interaction of the fluid within the energy exchanging device (100). The plurality of through slots (14, 17) may be defined in a major surface of the plurality of plates (2) by a through cut machining process. Here, it is to be interpreted that, a major surface may be defined as a surface about a width of each plate that may be traversed to extend along a length of corresponding plate of the plurality of plates (2). Each of the plurality of through slots (14, 17) in in each plate of the plurality of plates (2) may define a flow channel for flow of fluid.

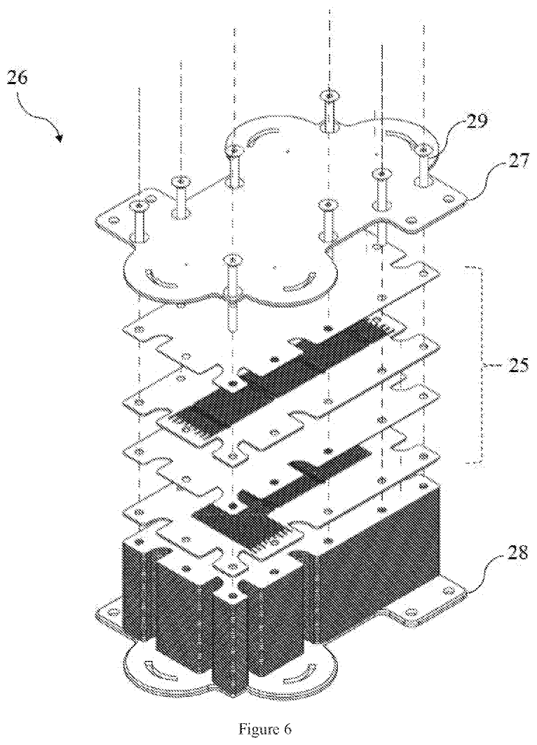

In an embodiment, the core (1) may further include at least one blanking member (24), that may be positioned at both the major surfaces of each of the plurality of plates (2). The at least one blanking member (24) may be stacked by positioning and/or introducing the at least one blanking member (24) between at least two successive plates of the plurality of plates (2). In the illustrative embodiment and as best seen in FIG. 5, each of the plurality of plates (2) having the plurality of through slots (14, 17) may be peripherally and/or planarly laminated by the at least one blanking member (24). Such positioning of the at least one blanking member (24) may form a plurality of fluid flow paths about the plurality of through slots (14, 17) between at least two successive plates of the plurality of plates (2). The at least one blanking member (24) may be bonded with the major surface of each of the plurality of plates (2), to form the energy exchanging core (1). In an embodiment, the at least one blanking member (24) may be integrally formed on at least one major surface of each plate of the plurality of plate (2), in order to define adequate separation between at least two successive plates of the plurality of plates (2) for forming the flow fluid flow path in the energy exchanging core (1). Furthermore, the energy exchanging core (1) may also include at least two inlet ports (45a, 45b) and at least two outlet ports (46a, 46b) for supplying and/or channelizing fluid into and out from the energy exchanging core (1). Here, it may be construed that the energy exchanging core may also be operable with one inlet port (45a, 45b) and one outlet port (46a, 46b), based on parameters such as, nature of energy exchanging core, characteristics of fluid being supplied, nature of energy being exchanged, quantity of fluid being supplied for exchanging energy and other parameters related to dimension of the energy exchanging device (100). The at least two inlet ports (45a, 45b) and at least two outlet ports (46a, 46b) may be defined by selectively machining portions of the at least one blanking member (24) and the plurality of plates (2). The at least two inlet ports (45a, 45b) and the at least two outlet ports (46a, 46b) facilitate the entry and exit of the fluid, respectively, from the core (1). Fluid introduced by the at least two inlet ports (45a, 45b) into the core (1), flows through the plurality of fluid flow paths within the core (1), and exits the core (1) through the at least outlet ports (46a, 46b), while undergoing energy exchange therewithin. Additionally, at least one manifold (38) may be fluidically connected to each of the at least two inlet ports (45a, 45b) and the at least two outlet ports (46a, 46b) to supply and circulate the fluid through the energy exchanging core (1).

Referring now to FIGS. 3a to 3c and 4a to 4c, the plurality of plates (2) are illustrated with the plurality of slots (14, 17) in different pattern and/or configuration. Such difference in pattern and/or configuration of the plurality of slots (14, 17) may be employed to selectively vary rate at which energy may be exchanged within the core (1). For employing the energy exchanging device (100) in exchanging of heat between two fluids, at least two consecutive plates of the plurality of plates (2) being stacked upon the at least one blanking plate (24), are to be defined the plurality of through slots (14, 17) with different patterns. For example, some of plates of the plurality of plates (2) may include configuration as illustrated in a first plate seen in FIGS. 3a to 3c, which may be referred to as a hot fluid plate (3) [that is, a fluid at ambient room temperature or elevated temperature may be channelized into the plurality of through slots (14, 17)], in the example of exchanging heat between two fluids. as illustrated in FIG. 3a or may include configuration as illustrated in a second plate seen in FIGS. 4a to 4c, which may be referred to as a cold fluid plate (4) [that is, a fluid at ambient room temperature or depressed temperature or lower temperature than the hot fluid may be channelized into the plurality of through slots (14, 17)] as illustrated in FIG. 4a, or vice versa. The first plate (3) (for simplicity of explanation in exchanging of heat between two fluids the first plate may hereafter be referred to as hot fluid plate (3)) may be dimensioned by a first pair of ventral surfaces (5a and 5b) and a second pair of ventral surfaces (6a and 6b), that are defined in a longitudinal direction (7) and a widthwise direction (8), respectively, of the hot fluid plate (3). The first pair of ventral surfaces (5a and 5b) may be substantially parallel to each other, and likewise, the second pair of ventral surfaces (6a and 6b) may be substantially parallel to each other. On the other hand, the first pair of ventral surfaces and the second pair of ventral surfaces may be oblique to one another or to each other, based on required shape and configuration of the hot fluid plate (3) in the core (1). In an embodiment, the hot fluid plate (3) may be a circular plate defined the plurality of through slots (14, 17), in which, the first pair and second pair of ventral surfaces are defined along two opposing radial directions, defined about the thickness of the hot fluid plate (3). Further, distance between the first pair of ventral surfaces (5a and 5b) defines the width of the hot fluid plate (3). Correspondingly, distance between the second pair of ventral surfaces (6a and 6b) defines the length of the hot fluid plate (3). Further, the first pair of ventral surfaces (5a and 5b) and the second pair of ventral surfaces (6a and 6b) may be substantially orthogonal or may be perpendicular to each other. Distance between a top surface and a bottom surface of the hot fluid plate (3) defines a thickness of the hot fluid plate (3). The hot fluid plate (3) may include a plurality of holes (9) defined at the vicinity of the first pair of ventral surfaces (5a and 5b) and the second pair of ventral surfaces (6a and 6b). The plurality of holes (9) may be configured to facilitate the stacking of the plurality of plates (2) by allowing a sleeve, including, but not limited to, a shank portion of a fastener, to be inserted therein. In the embodiment, the plurality of through slots (14) may be defined along the longitudinal direction (7), between the second pair of ventral surfaces (6a and 6b). The plurality of through slots (14) may be defined at a distance from the first pair of ventral surfaces (5a and 5b) and second pair of ventral surfaces (6a and 6b). The plurality of through slots (14) may be defined with a marginal space (19) at the second pair of ventral surfaces (6a and 6b) of the hot fluid plate (3). In addition, the hot fluid plate (3) may include a plurality of cutouts (21) defined at the vicinity of the first pair of ventral surfaces (5a and 5b) and the second pair of ventral surfaces (6a and 6b).

In an embodiment, the plurality of through slots (14) of the hot fluid plate (3) may be a straight profile extending between the second pair of ventral surfaces (6a and 6b) with the marginal space (19) at the edges of the hot fluid plate (3). As illustrated in FIG. 3a, the fluid flow path defined about the plurality of through slots (14) may be varied by incorporating other profiles in the pattern of the plurality of through slots (14) including, but not limited to, crests and troughs, angular deviations, and the any other profile that may enable increase in length of such fluid flow path. Such increase in the length of the fluid flow path may also increase interaction of the fluid flowing therethrough, with either of the fluid in the core (1) or with the core (1) itself, for energy exchange. In the embodiment, the plurality of through slots (14) of the hot fluid plate (3) may also be a S-profile, Z-profile, spiral or any other profile or combination of different profiles that extends between the second pair of ventral surfaces (6a and 6b) with the marginal space (19) at the edges of the hot fluid plate (3). Removal of material from the marginal space (19) results in exposure of the inlet and outlet portions of the plurality of through slots (14) of the hot fluid plate (3). In the illustrative embodiment of FIG. 3a, the plurality of through slots (14) may include crests and troughs that may be alternatively positioned and may be equidistant from one another. In the embodiment, the plurality of through slots (14) may be defined in sets and may not be equidistant from one another. The positioning of the plurality of crests and troughs in any two adjacent through slots (14) may be uniform. Further, as illustrated in FIG. 3b, the plurality of through slots (14) of the hot fluid plate (3) may be a wavy profile or a wavelike pattern, in which the length of the plurality of through slots (14) may be uniform. Furthermore, as illustrated in FIG. 3c, the plurality of through slots (14) of the hot fluid plate (3) may be a wavy profile or a wavelike pattern, in which the length of any two adjacent through slots (14) may be different or non-uniform.

In an embodiment, the second plate (4) (for simplicity of explanation in exchanging of heat between two fluids the second plate may hereafter be referred to as cold fluid plate (4)) The cold fluid plate (4) as illustrated in FIG. 4a, the plurality of through slots (17) may be delimited by a third pair of ventral surfaces (15a and 15b) and a fourth pair of ventral surfaces (16a and 16b), that are defined in a longitudinal direction (7) and a widthwise direction (8), respectively, of the cold fluid plate (4). The third pair of ventral surfaces (15a and 15b) may be substantially parallel to each other, and likewise, the fourth pair of ventral surfaces (16a and 16b) may be substantially parallel to each other. On the other hand, the third pair of ventral surfaces and the fourth pair of ventral surfaces may be oblique to one another or to each other, based on required shape and configuration of the hot fluid plate (3) in the core (1). In an embodiment, the cold fluid plate (4) may be a circular plate defined the plurality of through slots (17), in which, the third pair and fourth pair of ventral surfaces are defined along two opposing radial directions, defined about the thickness of the cold fluid plate (4). In the embodiment, the plurality of through slots (17) of the cold fluid plate (4) may have a profile similar to that of the hot fluid plate (3). Distance between the third pair of ventral surfaces (15a and 15b) defines the width of the cold fluid plate (4). Correspondingly, distance between the fourth pair of ventral surfaces (16a and 16b) defines the length of the cold fluid plate (4). Further, the third pair of ventral surfaces (15a and 15b) and the fourth pair of ventral surfaces (16a and 16b) may be substantially orthogonal or may be perpendicular to each other. Distance between a top surface and a bottom surface of the cold fluid plate (4) defines a thickness of the cold fluid plate (4). The cold fluid plate (4) includes a plurality of holes (18) defined at the vicinity of the third pair of ventral surfaces (15a and 15b) and the fourth pair of ventral surfaces (16a and 16b). The plurality of holes (18) may be configured to facilitate the stacking of the plurality of plates (2) by allowing a fastener to be inserted therein. In addition, in a manner similar to the hot fluid plate (3), the cold fluid plate (4) may also include a plurality of cutouts (22) defined at the vicinity of the third pair of ventral surfaces (15a and 15b) and the fourth pair of ventral surfaces (16a and 16b).

In the embodiment, the plurality of through slots (17) (as shown in FIG. 4a) of the cold fluid plate (4a) may be a S-shaped profile extending between the third pair of ventral surfaces (15a and 15b) of the cold fluid plate (4). The plurality of through slots (17) may include three sections, namely, a first section (17a), a second section (17b) and a third section (17c) (as depicted in FIG. 4a). The first and the third sections (17a and 17c) may be substantially parallel to the fourth pair of ventral surfaces (16a and 16b) and to each other (again referring to FIG. 4a). The first and the third sections (17a and 17c) may be separated by a distance between them, which is equivalent to the length of the second section (17b) of the plurality of the through slots (17). The second section (17b) of the plurality of the through slots (17) may be configured to join the first and the third sections (17a and 17c) of the plurality of through slots (17). In the embodiment, the plurality of through slots (17) may be defined at a distance from the third pair of ventral surfaces (15a and 15b) and the fourth pair of ventral surfaces (16a and 16b). The first and the third sections (17a and 17c) of the plurality of through slots (17) may be defined with a marginal space (20) at the third pair of ventral surfaces (15a and 15b) of the cold fluid plate (4). Removal of material from the marginal space (20) results in exposure of the inlet and outlet portions of the plurality of through slots (17) of the cold fluid plate (4). As illustrated in FIG. 4a, the second section (17b) of the plurality of the through slots (17) may be a straight profile including a plurality of crests and troughs. The crests and troughs may be alternatively positioned and may be equidistant from one another. The positioning of the plurality of crests and troughs in any two adjacent through slots (17) may be uniform.

Further, as illustrated in FIG. 4b, the first, the second and the third sections (17a, 17b and 17c) of the plurality of through slots (17) may be a wavy profile or a wavelike pattern, in which the length of the three sections (17a, 17b and 17c) of the plurality of through slots (17) may be uniform. Furthermore, as illustrated in FIG. 4c, the first, the second and the third sections (17a, 17b and 17c) of the plurality of through slots (17) may be a wavy profile or a wavelike pattern, in which the length of any two adjacent through slots (17) may be different or non-uniform.

FIG. 5 illustrates an exploded perspective view (23) of a stack of the plurality of plates (2) included in the core (1). In the illustrative embodiment, the stack includes two plates and three blanking members, however, the number of plates and the blanking members may be varied as per requirement and dimension of the core. Also, it would be understood that the number of blanking plates would generally be greater than the number of plates by at least one so that, each plate of the plurality of plates is sandwiched by the at least one blanking member on either side. Based on parameters including, but not limited to, rate of energy exchanging, nature of energy being exchanges and duration for interaction between at least one of the plurality plates, each blanking member and fluid flowing within the core (1), the number of blanking members being positioned between at least two plate of the plurality of plates may be varied. For example, in a PCHE for heat exchanging between two or more fluids, the core includes the at least one hot fluid plate (3a), the at least one cold fluid plate (4a) and the at least three blanking members (24). The at least one hot fluid plate (3a) may be positioned above the at least one cold fluid plate (4a) or vice versa, while the at least one blanking member (24) positioned therebetween. Further, at least one blanking member (24) may be placed above and below the at least one cold fluid plate (4a) and the at least one hot fluid plate (3a), respectively, to form a stack with the plates and the blanking members.

The stack formed by such positioning of the plates ensures that each of the at least one hot fluid plate (3a) and the at least one cold fluid plate (4a) is laminated by the at least one blanking member (24). Furthermore, the stack formed by such positioning of plates constitutes a unit (25) of the core (1) (also referred to as unit member or unit hereinafter) of the core (1). The core (1) of the device (100) may be formed by stacking of plurality of such units (25). In the embodiment, the at least one blanking member (24) may be a solid plate without any through slots or flow channels. In another embodiment, the at least one blanking member (24) may be a selective diffusion membrane without any through slots or flow channels.

FIG. 6 illustrates an exploded perspective view (26) of the energy exchanging core (1) of the device (100). The core (1) may be formed by stacking of a plurality of units (25). A top cover plate (27) and a bottom cover plate (28) may be positioned above and below the plurality of units (25).

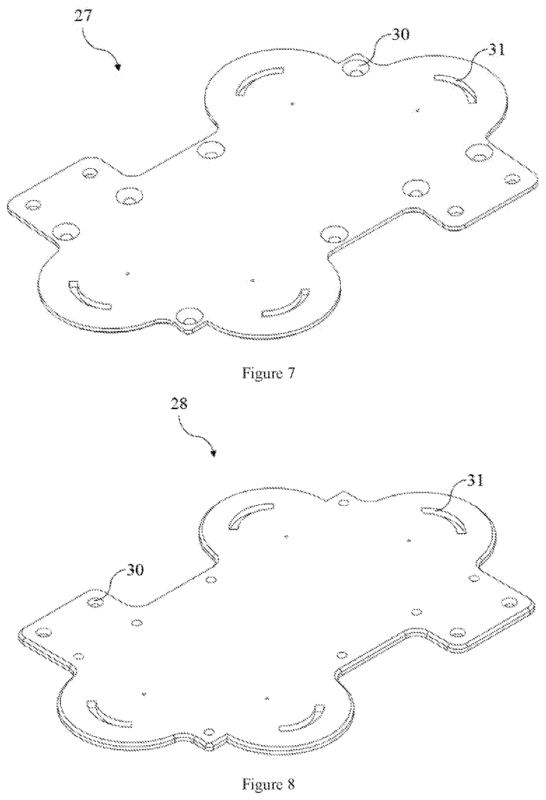

The top cover plate (27) may be positioned above a topmost unit (25) of the core (1), while the bottom cover plate (28) may be positioned below a bottom most unit (25) of the core (1). FIGS. 7 and 8 illustrate a perspective view of such top cover plate (27) and the bottom cover plate (28), respectively. The top cover plate (27) and the bottom cover plate (28) may include a plurality of holes (30) defined on a major surface of the plates. The plurality of holes (30) may be configured to facilitate the positioning of the top and the bottom cover plates (27 and 28), above and below the plurality of units (25), by allowing a fastener to be inserted therein. In addition, the top cover plate (27) and the bottom cover plate (28) may include a plurality of curved cutouts (31) configured to accommodate a top section (33) and a bottom section (34) of at least one diffuser (32).

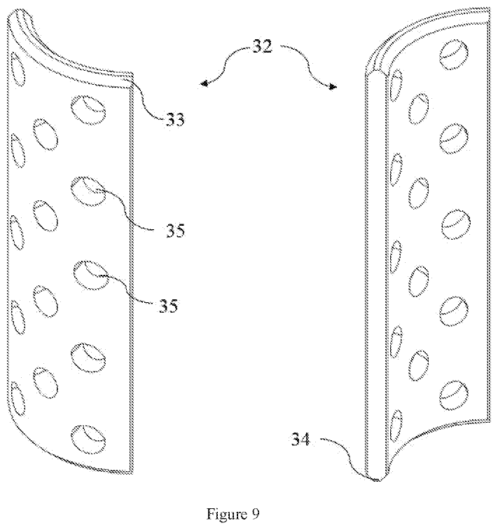

FIG. 9 illustrates a first perspective view and a second perspective view of an embodiment of the at least one diffuser (32). In an embodiment, the diffuser may be a cylindrical diffuser. A top section (33) and a bottom section (34) of the at least one diffuser (32) may be accommodated within the plurality of curved cutouts (31), as best seen in FIGS. 7 and 8, of the top cover plate (27) and the bottom cover plate (28). The at least one diffuser (32) may include a plurality of holes (35) configured to reduce and/or eliminate non uniformity in flow distribution and flow collection of the fluid. The plurality of holes (35) disperse the incoming and/or outgoing fluid, at the at least two inlet ports (45a, 45b) and at least two outlet ports (46a, 46b) of the core (1), to reduce and/or eliminate non uniformity in flow distribution and flow collection of the fluid. The at least one diffuser (32) may be positioned at the vicinity of the at least two inlet ports (45a, 45b) and at least two outlet ports (46a, 46b) of the core (1), for flow distribution of the fluid at the at least two inlet ports (45a, 45b) and flow collection of the fluid at the at least two outlet ports (46a, 46b), respectively.

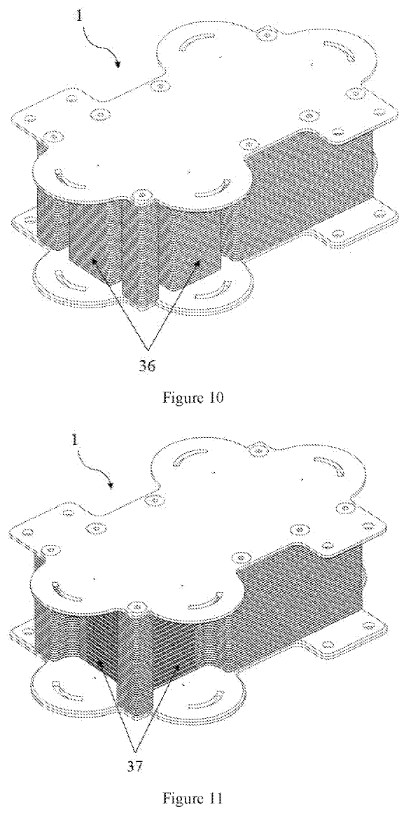

FIG. 10 is an exemplary embodiment of the present disclosure which illustrates an assembled perspective view of the core (1) of the energy exchanging device (100). Prior to attachment of manifolds (38) to the core (1), a machining operation, including, but not limited to milling or any other surface material removal process, that may be performed on the core (1), to remove material at the marginal spaces (19 and 20) of the plurality of plates (2). The assembled core (1), assembled with the at least one diffuser (32), includes marginal spaces (19 and 20) about ventral surfaces such that, removal of material from the marginal spaces (19 and 20) results in exposure of the inlet and outlet portions of the plurality of through slots (14, 17) of the hot and cold fluid plate (3, 4).

Pointer 36 depicts region around such marginal spaces (19 and 20) requiring material removal, while pointer 37 depicts region around such marginal spaces (19 and 20) after such material removal. Subsequent to machining operation, excess material that may be left at the marginal spaces (19 and 20), may be removed by a material removal process, such as, but not limited to, laser-based material ablation, scarfing, grinding, micro milling, Wire Electro Discharge Machining, Spark Erosion, waterjet cutting and by use of a pencil cutter or any other material removal process. As mentioned earlier, removal of material from the marginal spaces (19 and 20) results in exposure of the inlet and outlet portions of the plurality of through slots (14, 17) of the plurality of plates (2). The core (1), subsequent to removal of material from the marginal spaces (19 and 20), is illustrated in FIG. 11. Further, in an embodiment, the machining operation may be performed subsequent to completion of the step of bonding the at least one blanking member (24) with the major surface of each of the plurality of plates (2).

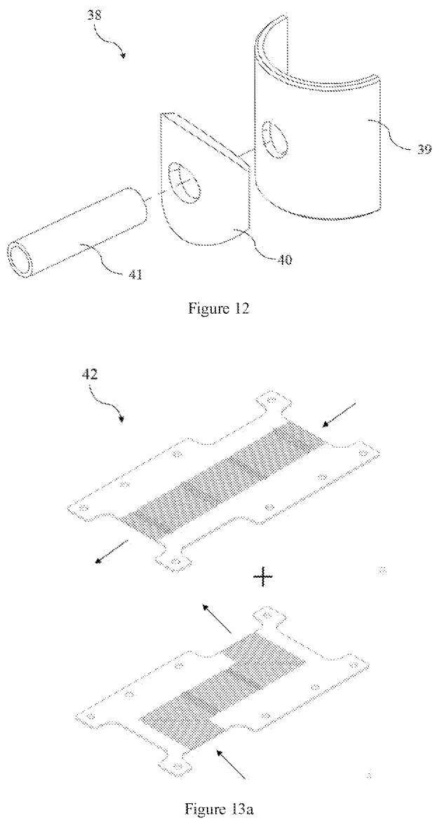

FIG. 12 is an exemplary embodiment of the present disclosure which illustrates an exploded perspective view of a manifold (38) of the device (100). The manifold (38) may be configured to supply fluid to the core (1) of the device (100). The manifold (38) may include a cylindrical header (39), reinforcement plate (40) and a conduit (41). The manifold (38), as depicted in FIG. 2, may be positioned to cover or partially enclose the at least one diffuser (32) positioned at the vicinity of the at least two inlet ports (45a, 45b) and at least two outlet ports (46a, 46b) of the core (1).

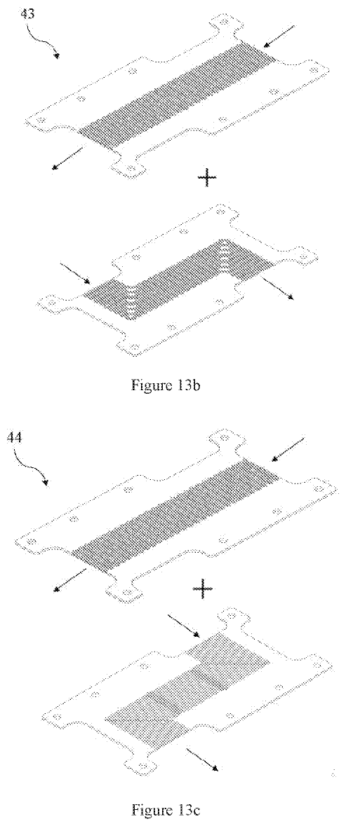

FIGS. 13a, 13b and 13c illustrate various combinations of the hot fluid plate (3) and the cold fluid plate (4) that may be employed in formation of the unit (25). Pointers in the figures depict the direction of flow of fluid within the plurality of through slots (14, 17). Further, the core (1) may also be formed by employing two or more combinations of the hot fluid plate (3) and the cold fluid plate (4). In an embodiment, the hot fluid plates (3) and the cold fluid plates (4) may be arranged to have fluid interactions in at least one of a parallel flow, counter flow, cross flow, and any other combination that may enable prolonged interaction between the fluids flowing through the plurality of plates to interact and exchange energy such as heat and/or charge by ion exchange.

In the embodiment, the flow rate of the fluid in the plurality of plates (2), including the hot fluid plate (3) and the cold fluid plate (4), may be uniform based on energy exchanging requirement of the core (1). In the embodiment, the flow rate of the fluid in the plurality of plates (2), including the hot fluid plate (3) and the cold fluid plate (4), may be non-uniform based on energy exchanging requirement of the core (1). Further, the flow rate of the fluid in the plurality of plates (2) may be varied based on the profile of the plurality of through slots (17). In the embodiment, the flow rate of the fluid in the plurality of plates (2) may be kept constant over a period of time. In the embodiment, the flow rate of the fluid in the plurality of plates (2) may be varied over a period of time. In another embodiment, when the core (1) is being used for energy exchange, a first fluid may be contained within the core (1) such that the first fluid is accommodated over a first side of the blanking member (24), while a second fluid may be flowing continuously through the core (1), where such second fluid may be flowing on a second side of the blanking member (24). In such embodiment, the first fluid and the second fluid may be a hot fluid and a cold fluid or vice versa.

In addition, in such embodiment, the first fluid may be an electrolyte solution and the second fluid may be a saturated ion carrier solution and vice versa.

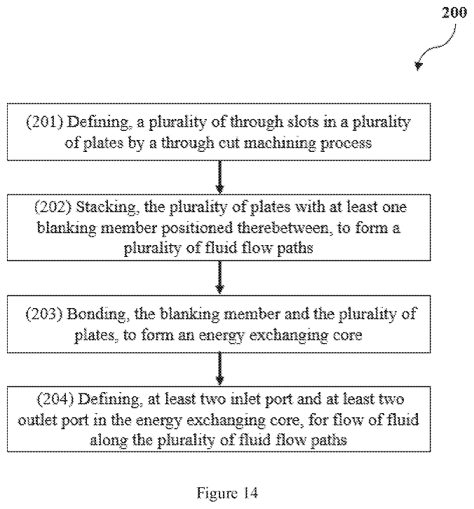

FIG. 14 is a flow chart of a method (200) of manufacturing the energy exchanging device. In an embodiment, the method may be implemented to manufacture any energy exchanging device including, but not limited to, a micro-channel heat exchanger, a printed circuit heat exchanger (PCHE) and a compact plate heat exchanger and fuel cell.

The order in which the method is described is not intended to be construed as a limitation, and any number of the described method blocks may be combined in any order to implement the method.

Additionally, individual blocks may be deleted from the methods without departing from the scope of the subject matter described herein.

As depicted at block 201, the method (200) includes step of defining a plurality of through slots (14, 17) in a major surface of the plurality of plates (2). The plurality of through slots (14, 17) may be defined by a through cut machining process. In an embodiment, the through cut machining process may include at least one of the processes such as, but not limited to, a laser machining, wire electrical discharge machining (wire EDM), and spark erosion machining or any other machining process. Also, the through slots may be integrally formed during manufacturing of each plate of plurality of plates, without having to remove material from the plurality of plates post manufacturing, where such manufacturing processes include, forming, casting, 3D printing, powder manufacturing, and any other process which results in formation of through slots while manufacturing the plurality of plates. Additionally, conventional machining process such as, milling, slot boring, drilling, and other machining processes may be employed for defining the through slots in the plurality of plates. Further, each of the plurality of through slot, defined in each of the plurality of plates (2), defines a flow channel for flow of fluid. The plurality of flow channels may be defined with a profile including at least one of a straight profile, zig-zag profile, serpentine profile, and S-shaped profile or any other shape including any combination of above. Further, the plurality of through slots (14, 17), defined on the major surface of each of the plurality of plates (2), may be defined with a marginal space at edges of the corresponding plate of the plurality of plates (2). The marginal space may be configured to hold material of corresponding plate, which upon removal, defines inlet and/or outlet of the through slots (14, 17) in such plate of the plurality of plates (2). In the embodiment, the plurality of plates (2), the at least one blanking member (24), and the top and the bottom cover plates (27 and 28), may be made of steel, stainless steel, nickel-molybdenum alloy such as Hastelloy*, nickel-chromium-based superalloys such as Inconel*, duplex stainless steels, titanium, aluminum, carbon fiber, polymer, processed powder material, or any other rigid material that is deemed suitable. In addition, the plurality of plates (2), the at least one blanking member (24), and the top and the bottom cover plates (27 and 28), may also be made of cellulose fibres, glass fibre papers, porous polymer films, thin film composites, laminated membranes and sulphonated and carboxylated ionomer films.

As depicted at block 202, the method (200) includes the step of stacking the plurality of plates (2) with at least one blanking member (24) positioned at both the major surfaces of each of the plurality of plates (2). In an embodiment, the blanking member (24) may be at least one of a solid plate and a selective diffusion membrane, such as, but not limited to, Nafion, Polymer membrane, Liquid electrolytes with redox shuttle and polymer membrane, Sulfonated polymers such as Polyether ether ketone (s-PEEK), polysulphone polybenzimidazole and the like. The selective diffusion membrane enables exchange of fluid and ions included within the fluid flowing through the plurality of plates (2), resulting in an energy exchange therebetween. Further, such stacking of the plurality of plates (2) with at least one blanking member (24) positioned therebetween, results in formation of a plurality of fluid flow paths about the plurality of through slots (14, 17). In the embodiment, the plurality of plates (2) spaced by the at least one blanking member (24) may be stacked such that, each plate of the plurality of plates (2) on either side of the at least one blanking member (24) may be defined with the plurality of flow channels. Furthermore, stacking of the plurality of plates (2) includes disposing the at least one blanking member (24) to form a base for the energy exchanging core (1). Subsequent to such stacking, the method includes interposing at least one plate of the plurality of plates (2) between the plurality of blanking members (24). Particularly, the plurality of plates (2) and the at least one blanking member (24) are progressively and relatively positioned such that, the at least one blanking member (24) on both the major faces of each plate define the plurality of fluid flow paths about the plurality of through slots (14, 17) for fluid flow through the energy exchanging core (1).

As depicted at block 203, the method (200) further includes the step of bonding the at least one blanking member (24) with the major surface of each of the plurality of plates (2). Such bonding may be performed to form the energy exchanging core (1) of the energy exchanging device (100). The step of bonding further includes applying an adhesive bond between the major surface of the plurality of plates (2) and the at least one blanking member (24) while stacking. Subsequent to application of adhesive bond, the method includes heating the stack of the plurality of plates (2) and the at least one blanking member (24), by a joining process, to form the energy exchanging core (1). The joining process may include at least one of a process such as, but not limited to, a vacuum brazing, diffusion bonding, soldering and welding. In an embodiment, the joining process employed may be the vacuum brazing process. Vacuum brazing process ensures that the core (1) possesses high mechanical strength, making it suitable for operation under extreme pressure and temperature environments.

In an embodiment, prior to carrying out of the vacuum brazing process, the plurality of the plates of the core (1) including the hot fluid plate (3), cold fluid plate (4), blanking member (24), top cover plate (27) and the bottom cover plate (28) may be buffed and may be cleansed with a suitable solvent to remove dirt, oil or any oxides present on the surface of the plurality of the plates. Further, a brazing tape, such as, but not limited to, a BNi-7 (a nickel-based filler metal used in brazing) material tape may be pasted on both sides of the blanking member (24). Fixture plates may be employed to apply pressure and tighten the stack or the plurality of units (25) included within the core (1). A plurality of fasteners, such as, but not limited to, bolts, rivets, screws, may be fastened in the plurality of holes (30) of the top cover plate (27) and the bottom cover plate (28). In the embodiment, a plurality of bolts may be fastened in the plurality of holes (30) of the top cover plate (27) and the bottom cover plate (28). Usage of such fixture plates and fasteners during vacuum brazing, ensures that the plurality of flow channels of the core (1) have uniform geometry.

In the embodiment, the plurality of fasteners may also include a fastener such as, but not limited to, a hydraulically loaded fastener, spring force fastener, and spring loaded fasteners. Further, a parting compound, such as, but not limited to, White Stop-Off™ may be applied to the fixture plates and the fasteners, to prevent accidental brazing of adjoining surfaces of the fixture plates & fasteners, during vacuum brazing. Subsequent to application of parting compound, the core (1) may be placed in a furnace for vacuum brazing. The core (1) may be secured within the furnace and vacuum pumps associated with the furnace may be actuated to create vacuum within the furnace. Upon reaching a set vacuum level of 1×10⁻³ to 1×10⁻⁹ Torr within the furnace, power panels of the furnace may be switched on and a vacuum brazing cycle may be initiated.

As depicted at block 204, the method (200) further includes the step of defining at least two inlet ports (45a, 45b) and at least two outlet ports (46a, 46b) in the energy exchanging core (1). Defining the at least two inlet ports (45a, 45b) and the at least two outlet ports (46a, 46b) includes machining a portion of the blanking member (24) and the marginal space defined at the opposing ends of the plurality of plates (2) by a material removal process. The material removal process may include at least one of a process such as, but not limited to a milling, drilling, blanking and wire electrical discharge machining (wire EDM), spark erosion, Electrochemical etching, waterjet cutting or any other machining process. The inlet ports (45a, 45b) and the outlet ports (46a, 46b) facilitate the entry and exit of the fluid, respectively, from the energy exchanging core (1). Fluid introduced by the inlet ports (45a, 45b) into the core (1), flows through the plurality of fluid flow paths within the core (1), and exits the core (1) through the outlet ports (46a, 46b), while undergoing energy and/or heat exchange therewithin. The method may further include fluidically connecting the at least one manifold (38) to each of the at least two inlet ports (45a, 45b) and the at least two outlet ports (46a, 46b) to supply and circulate the fluid through the core (1).

In an embodiment, the method (200) enables manufacture of energy exchanging devices (100) such as compact plate heat exchangers and PCHEs used extensively in processing industries including, but not limited to, food industry, pharmaceutical industry, thermal powerplants, oil refineries, battery modules, automotive industries and any other industry or application requiring efficient energy exchange between two fluids in a compact space. Further, the energy exchanging devices (100) manufactured by the method (200) of the present disclosure are characterized by low hold up volume and high heat transfer coefficients with significantly low-pressure drop. Such characteristics of the device (100) facilitate high energy/heat transfer rates with minimal start-up time. Performance of PCHEs, manufactured by the method (200) of the present disclosure, are at par with conventionally manufactured PCHEs. Further, by employing a through cut machining process such as laser cutting instead of photochemical etching, and by employing a bonding process such as vacuum brazing instead of diffusion bonding, the method (200) provides a viable and an economical alternative to a conventional method of manufacturing MCHEs. In comparison with the conventional method of manufacturing MCHEs, the method (200) significantly reduces costs and overall lead times associated with the manufacturing of MCHEs. Such reduction in costs and overall lead times may result in widespread adoption of MCHEs in industries and may further lead towards replacement of other type of energy/heat exchanging devices.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERICALS

| Particulars | Numerical |
|---|---|
| Conventional method of manufacturing PCHEs | 10 |
| Steps included in the conventional method of manufacturing | 11-13 |
| PCHEs | |
| Energy exchanging device | 100 |
| Energy exchanging core | 1 |
| Plurality of plates | 2 |
| Hot fluid plate | 3, 3a, 3b, 3c |
| Cold fluid plate | 4, 4a, 4b, 4c |
| First pair of ventral surfaces of the hot fluid plate | 5a and 5b |
| Second pair of ventral surfaces of the hot fluid plate | 6a and 6b |
| Longitudinal direction | 7 |
| Widthwise direction | 8 |
| Plurality of holes of hot fluid plate | 9 |
| Plurality of through slots of hot fluid plate | 14 |
| Third pair of ventral surfaces of cold fluid plate | 15a and 15b |
| Fourth pair of ventral surfaces of cold fluid plate | 16a and 16b |
| Plurality of through slots of cold fluid plate | 17 |
| Plurality of holes of the cold fluid plate | 18 |
| Marginal space defined in hot fluid plate | 19 |
| Marginal space defined in cold fluid plate | 20 |
| Plurality of cutouts defined in hot fluid plate | 21 |
| Plurality of cutouts defined in cold fluid plate | 22 |
| Exploded perspective view of a stack of the plurality of | 23 |
| plates | |
| Blanking member | 24 |
| Unit of the core member | 25 |
| Exploded perspective view of the energy exchanging core | 26 |
| Top cover plate | 27 |
| Bottom cover plate | 28 |
| Fastener | 29 |
| Plurality of holes defined in the top and bottom cover plate | 30 |
| Plurality of curved cutouts of the top and bottom cover | 31 |
| plate | |
| Diffuser | 32 |
| Top section of the diffuser | 33 |
| Bottom section of the diffuser | 34 |
| Plurality of holes defined in the diffuser | 35 |
| Pointers depicting region around marginal spaces | 36, 37 |
| Manifold | 38 |
| Cylindrical header | 39 |
| Reinforcement plate | 40 |
| Conduit | 41 |
| Perspective view of various combinations of the hot fluid | 42, 43, 44 |
| plate and the cold fluid plate | |
| Inlet ports | 45a, 45b |
| Outlet ports | 46a, 46b |
| Method of manufacturing the energy exchanging device | 200 |
| Steps included in the method of manufacturing the energy | 201-204 |
| exchanging device | |

1. A method of manufacturing an energy exchanging device, the method comprising:
defining, a plurality of through slots in a major surface of a plurality of plates by a through cut machining process, wherein, each of the plurality of through slot defines a flow channel;
stacking, the plurality of plates with at least one blanking member positioned at both the major surfaces of each of the plurality of plates to form a plurality of fluid flow paths about the plurality of through slots;
bonding, the at least one blanking member with the major surface of each of the plurality of plates, to form an energy exchanging core; and
defining, at least two inlet ports and at least two outlet ports in the energy exchanging core, for flow of fluid along the plurality of fluid flow paths within the energy exchanging core-.

2. The method as claimed in claim 1, wherein the through cut machining process includes at least one of a laser machining, wire electrical discharge machining, waterjet cutting, electrochemical etching, micro milling, and spark erosion machining.

3. The method as claimed in claim 1, wherein the plurality of through slots are defined on the major surface of each of the plurality of plates defining a marginal space at edges of the corresponding plate of the plurality of plates.

4. The method as claimed in claim 1, wherein the blanking member is at least one of a solid plate and a selective diffusion membrane.

5. The method as claimed in claim 1, wherein the plurality of flow channels are defined profile including at least one of a straight profile, zig-zag profile, serpentine profile, non-geometric profile, and S-shaped profile.

6. The method as claimed in claim 1, wherein the plurality of plates spaced by the at least one blanking member is stacked such that, each plate of the plurality of plates on either side of the at least one blanking member is defined with the plurality of flow channels with at least one predetermined profile including at least one of a straight profile, zig-zag profile, serpentine profile, non-geometric profile and S-shaped profile.

7. The method as claimed in claim 1, wherein stacking of the plurality of plates comprises:
disposing at least one blanking member to form a base for the energy exchanging core;
interposing at least one plate of the plurality of plates between the plurality of blanking members, wherein the plurality of plates and the at least one blanking member are progressively and relatively positioned such that, the at least one blanking member on both the major faces of each plate define the plurality of fluid flow path about the plurality of through slots for fluid flow through the energy exchanging core.

8. The method as claimed in claim 1, wherein the bonding includes:
applying, an adhesive bond between the major surface of the plurality of plates and the at least one blanking member while stacking; and
heating, the stack of the plurality of plates and the at least one blanking member by a joining process including at least one of a vacuum brazing, diffusion bonding, adhesive bonding, soldering and welding, to form the energy exchanging core.

9. The method as claimed in claim 1, wherein defining the at least two inlet ports and the at least two outlet ports in the energy exchanging core includes machining a portion of the blanking member and the marginal space defined at the opposing ends of the plurality of plates by a material removal process including at least one of a milling, drilling, blanking, waterjet cutting, electrochemical etching, micro milling, and wire electrical discharge machining process.

10. An energy exchanging device, the device comprising:
an energy exchanging core, comprising:
a plurality of plates, each defined with a plurality of through slots in a major surface by a through cut machining process, wherein each of the plurality of through slot defines a flow channel; and
at least one blanking member, positioned at both the major surfaces of the plurality of plates to form a plurality of fluid flow paths about the plurality of through slots, wherein the at least one blanking member is bonded with the major surface of each of the plurality of plates, to form an energy exchanging core;
wherein at least two inlet ports and at least two outlet ports are defined in the energy exchanging core by selectively machining portions of the at least one blanking member and the plurality of plates, for flow of fluid along the plurality of fluid flow paths within the energy exchanging core; and
at least one manifold fluidically connected to each of the at least two inlet ports and to each of the at least two outlet ports to circulate the fluid through the energy exchanging core.

11. The device as claimed in claim 10, wherein the plurality of through slots are defined on the major surface of each of the plurality plates defining a marginal space at edges of the corresponding plate of the plurality of plates.

12. The device as claimed in claim 10, wherein the plurality of flow channels are defined with a predetermined profile including at least one of a straight profile, zig-zag profile, serpentine profile, non-geometric profile, and S-shaped profile.

13. The device as claimed in claim 10, wherein the blanking member is at least one of a solid plate and a selective diffusion membrane.
